(19) United States
(12) Patent Application Publication
(10) Pub. No.: US 2010/0323893 A1
(43) Pub. Date: Dec. 23, 2010

(54) METHOD OF CONTROLLING WEEDS

(75) Inventor: Hajime IKEDA, Kobe-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/794,121

(22) Filed: Jun. 4, 2010

(30) Foreign Application Priority Data
Jun. 18, 2009 (JP) 2009-145149

(51) Int. Cl. A01N 43/84

(52) U.S. Cl. 504/130

(57) ABSTRACT

A method of controlling weeds in a soybean or cotton field, which comprises the step of applying an effective amount of flumioxazin and dicamba or an agriculturally acceptable salt thereof to the weeds or a place where the weeds are to grow.

### FIELD OF THE INVENTION

The present invention relates to a method of controlling weeds in a soybean or cotton field.

### BACKGROUND OF THE INVENTION

A lot of compounds are known as active ingredients of herbicides.

### SUMMARY OF THE INVENTION

An object of the present invention is to provide a method of controlling weeds in a soybean or cotton field.

According to the present invention, weeds in a soybean or cotton field can be effectively controlled by combined application or use of a combination of flumioxazin and dicamba in the soybean or cotton field.

The present invention includes the following:
[1] a method of controlling weeds in a soybean or cotton field, which comprises the step of applying an effective amount of flumioxazin and dicamba or an agriculturally acceptable salt thereof to the weeds in the soybean or cotton field or the place where the weeds are to grow;
[2] the method of controlling weeds according to [1], wherein a mixing weight ratio of flumioxazin to dicamba or an agriculturally acceptable salt thereof is from 1:0.001 to 1:600;
[3] the method of controlling weeds according to [1], wherein a mixing weight ratio of flumioxazin to dicamba or an agriculturally acceptable salt thereof is from 1:0.01 to 1:300;
[4] the method of controlling weeds according to [1], wherein a mixing weight ratio of flumioxazin to dicamba or an agriculturally acceptable salt thereof is from 1:1 to 1:150;
[5] the method of controlling weeds according to any one of [1] to [4], wherein the soybean field is for cultivating a transgenic soybean and wherein the cotton field is for cultivating a transgenic cotton;
[6] the method of controlling weeds according to any one of [1] to [4], wherein the soybean field is for cultivating a herbicide-resistant transgenic soybean and wherein the cotton field is for cultivating a herbicide-resistant transgenic cotton; and
[7] the method of controlling weeds according to any one of [1] to [4], wherein the soybean field is for cultivating a dicamba-resistant transgenic soybean and wherein the cotton field is for cultivating a dicamba-resistant transgenic cotton.

According to the present invention, weeds in a soybean or cotton field can be effectively controlled.

### DETAILED DESCRIPTION OF THE INVENTION

The method of controlling weeds in a soybean or cotton field of the present invention comprises the step of applying an effective amount of flumioxazin and dicamba or an agriculturally acceptable salt thereof to the weeds or the place where the weeds are to grow.

Flumioxazin used in the present invention is a compound having a chemical name of N-(7-fluoro-3,4-dihydro-3-oxo-4-prop-2-ynyl-2H-1,4-benzoxad in-6-yl)cyclohex-1-ene-1,2-dicarboxamide. Flumioxazin is a compound described in U.S. Pat. No. 4,640,707 and can be produced by the method described in the publication.

Dicamba used in the present invention is a compound having a chemical name of 2-(2-aminoethoxy)ethanol 3,6-dichloro-o-anisate. Dicamba is a compound described in U.S. Pat. No. 3,013,054 and can be produced by the method described in the publication.

Examples of the agriculturally acceptable salt of dicamba include dicamba diglycolamine salt, dicamba alkylamine salts, dicamba olamine salts, dicamba-methyl,and dicamba alkyl metal salts.

Specific examples of the agriculturally acceptable salt of dicamba include dicamba diglycolamine salt, dicamba dimethylamine salt, dicamba potassium and dicamba sodium.

In the method of controlling weeds of the present invention, a mixing weight ratio of flumioxazin to dicamba or an agriculturally acceptable salt thereof is usually from 1:0.001 to 1:600, preferably from 1:0.01 to 1:300, more preferably from 1:1 to 1:150, and further preferably from 1:1 to 1:50.

In the present invention, “effective amount” means the total application amount of flumioxazin and dicamba or capable an agriculturally acceptable salt thereof, which of these compounds can control the weeds in a soybean or cotton field.

In the method of controlling weeds of the present invention, the total application amount of flumioxazin and dicamba or an agriculturally acceptable salt is usually from 20 to 5,000 g, preferably from 50 to 2,000 g, and more preferably from 70 to 1,500 g, in terms of the total amount of flumioxazin and dicamba or an agriculturally acceptable salt thereof, per 10,000 m² of the soybean or cotton field.

In the method of controlling weeds of the present invention, flumioxazin and dicamba or an agriculturally acceptable salt thereof are mixed and then applied, or they are applied in combination.

Flumioxazin and dicamba or an agriculturally acceptable salt thereof may be applied respectively as they are, but may be applied respectively in the form of formulation or in the form of formulation containing both the compound. Examples of such formulation include oil solutions, emulsifiable concentrates, flowable formulations, wettable powders, granular wettable powders, dust formulations and granules. Formulation can be prepared by mixing flumioxazin, dicamba or an agriculturally acceptable salt, or both these compounds with an inert carrier, optionally adding surfactants and other adjuvants for formulation.

The total content of the active component, i.e. flumioxazin, dicamba or an agriculturally acceptable salt thereof, in the formulation is usually within a range from 0.1 to 99% by weight, preferably from 0.2 to 90% by weight, and more preferably from 1 to 80% by weight.

As examples of applying flumioxazin and dicamba or an agriculturally acceptable salt thereof to weeds in the soybean or cotton field or the place where weeds are to grow, such methods are shown as bellow:
a method in which a formulation of flumioxazin and a formulation of dicamba or an agriculturally acceptable salt thereof are respectively diluted with water and the respective water dilutions are mixed to prepare a mixed water dilution, and then mixed water dilution is applied to weeds in the soybean or cotton field or the place where weeds are to grow;
a method in which a formulation of flumioxazin and a formulation of dicamba or an agriculturally acceptable salt thereof are respectively diluted with water and then the respective water dilutions are sequentially applied to weeds in the soybean or cotton field or the place where weeds are to grow;
a method in which a formulation of flumioxazin and a formulation of dicamba or an agriculturally acceptable salt thereof are mixed and the mixture is diluted with water to prepare a water dilution, and then the water dilution is applied to weeds in the soybean or cotton field or the place where weeds are to grow, and
a method in which a formulation of dicamba or an agriculturally acceptable salt thereof is diluted with water and then a formulation of flumioxazin and the obtained water dilution are sequentially applied to weeds in the soybean or cotton field or the place where weeds are to grow.

In the method of controlling weeds of the present invention, flumioxazin and dicamba or an agriculturally acceptable salt thereof are applied to weeds or the place where weeds are to grow. When flumioxazin and dicamba or an agriculturally acceptable salt thereof are applied to weeds, they may be applied to weeds per se or to the soil where weeds have emerged. When flumioxazin and dicamba or an agriculturally acceptable salt thereof are applied to a place where weeds are to grow, they may be applied to a surface of the soil where weeds have not emerged yet.

In the method of controlling weeds of the present invention, flumioxazin and dicamba or an agriculturally acceptable salt thereof may be applied before sowing seeds of soybean or cotton, at sowing seeds of those, after sowing of those and before emergence of those, or after emergence of those.

According to the present invention, flumioxazin and dicamba or an agriculturally acceptable salt thereof may be applied in such embodiments as bellow:
a method of spraying over a surface of the soil before or at sowing seeds of soybean or cotton and before weed emergence;
a method of spraying over a surface of the soil before or at sowing seeds of soybean or cotton and after weed emergence;
a method of spraying over weeds before or at sowing seeds of soybean or cotton and after weed emergence;
a method of spraying over a surface of the soil after sowing seeds of soybean or cotton and before emergence of soybean or cotton, and before weed emergence;
a method of spraying over a surface of the soil after sowing seeds of soybean or cotton, before emergence of soybean or cotton, and after weed emergence;
a method of spraying over weeds after sowing seeds of soybean or cotton, before emergence of soybean or cotton, and after weed emergence;
a method of spraying over a surface of the soil after emergence of soybean or cotton and before emergence of weeds;
a method of spraying over a surface of the soil after emergence of soybean or cotton and after emergence of weeds; and/or
a method of spraying over weeds after emergence of soybean or cotton soybean or cotton and after emergence of weeds.

In the weed control method of the present invention, the soybean field may be for cultivating a transgenic soybean, and the cotton field may be for cultivating a transgenic cotton.

Examples of the transgenic soybean and transgenic cotton include soybeans or cottons provided with resistance to herbicides, including 4-hydroxyphenylpyruvate dioxygenase inhibitors such as isoxaflutole; acetolactate synthase (hereinafter abbreviated to ALS) inhibitors such as imazethapyr and thifensulfuron-methyl; 5-enolpyruvylshikimate-3-phosphate synthase (hereinafter abbreviated to EPSP) inhibitors such as glyphosate; glutamine synthase inhibitors such as glufosinate; auxin-type herbicides such as 2,4-D and dicamba; protoporphyrinogen IX oxidase-inhibiting herbicides such as flumioxazin and fomesafen; and bromoxynil, by way of a genetic recombination technology.

Examples of the transgenic soybean and transgenic cotton include soybean and cotton cultivars resistant to glyphosate, which have been already on the market under the trade names of RoundupReady®, Agrisure® GT and Glytol®. Examples of the transgenic soybean and transgenic cotton include soybean and cotton cultivars provided with resistance to glufosinate, which have been already on the market under the trade name of LibertyLink®. Examples of the transgenic cotton include cotton cultivars provided with resistance to bromoxynil, which have been already on the market under the trade name of BXN. Examples of the transgenic soybean include soybean cultivars provided with resistance to both glyphosate and ALS inhibitors, which are laid open under the trade names of Optimum® and GAT®.

Examples of the plants provided with resistance to the acetyl CoA carboxylase inhibitor are described in Proc. Natl. Acad. Sci. USA), Vol. 87, pp .7175-7179 (1990) or the like. Also, mutated acetyl CoA carboxylase, which is resistant to the acetyl CoA carboxylase inhibitor, is reported in the Weed Science, Vol. 53, pp .728-746 (2005). The plants with resistance to the acetyl CoA inhibitor is fabricated by introducing such a mutated acetyl CoA carboxylase gene into a crop by means of genetic recombination technology, or by introducing resistance-providing mutation into acetyl CoA carboxylase of the crop.

Further, by introducing base substitute mutagenesis nucleic acid into a plant cell and inducing site-specific amino acid substitute mutation to the plant acetyl CoA carboxylase gene and ALS gene, the technology represented by chimeraplasty technology (Gura T., Repairing the Genome's Spelling Mistakes, Science 285: 316-318 (1999)), plants resistant to acetyl CoA carboxylase inhibitors and ALS inhibitors are fabricated.

By introducing a degrading enzyme of dicamba, which contains dicamba monooxygenase isolated from Pseudomonas maltophilia, crops such as soybean resistant to dicamba can be fabricated (Behrens et al. 2007 Dicamba Resistance: Enlarging and Preserving Biotechnology-Based Weed Management Strategies. Science 316:1185 to 1188).

By introducing gene encoding aryloxyalkanoate dioxygenase, crops resistant to both herbicide systems of phenoxy acid herbicides such as 2,4-D, MCPA, dichlorprop and mecoprop, and aryloxyphenoxypropionic acid herbicides such as quizalofop, haloxyfop, fluazifop, diclofop, fenoxaprop, metamifop, cyhalofop and clodinafop can be fabricated (WO05/107437, WO07/053482, WO08/141154).

A crop plant resistant to HPPD inhibitors can be produced by introducing a gene encoding HPPD which shows resistance to HPPD inhibitors (US2004/0058427). A crop plant resistant to HPPD inhibitors can be produced by introducing genes encoding enzymes which caralyze HPPD-independent homogentisate synthesis (WO02/036787). A crop plant resistant to HPPD inhibitors can be produced by introducing a gene encoding over-expressing HPPD (WO96/38567). A crop plant resistant to HPPD inhibitors can be produced by introducing a gene encoding prephenate dehydrogenase to increase p-hydoroxyphenylpyruvate flux in a plant over-expressing HPPD (Rippert P et.al. 2004 Engineering plant shikimate pathway for production of tocotrienol and improving herbicide resistance. Plant Physiol. 134:92-100).

The transgenic soybean and transgenic cotton also include soybean and cotton which made it possible to synthesize selective toxins known as genus Bacillus, using genetic recombination technology.

Examples of the insecticidal toxins expressed in such transgenic soybean and transgenic cotton include insecticidal proteins derived from Bacillus cereus and Bacillus popilliae; δ-endotoxins derived from Bacillus thuringiensis, e.g. Cry1Ab, Cry1Ac, Cry1F, Cry1Fa2, Cry2Ab, Cry3A, Cry3Bb1 and Cry9C, and insecticidal proteins such as VIP1, VIP2, VIP3 and VIP3A; insecticidal toxins derived from nematodes; insecticidal toxins produced by animals, such as scorpion toxin, spider toxin, bee toxin and insect-specific neurotoxins; filamentous fungi toxins; plant lectins; agglutinin; protease inhibitors such as trypsin inhibitors, serine protease inhibitor, patatin, cystatin and papain inhibitors; ribosome-inactivating proteins (RIP) such as ricin, corn-RIP, abrin, rufin, sapolin and priodin; steroid metabolic enzymes such as 3-hydroxysteroid oxidase, ecdysteroid-UDP-glucosyltransferase and cholesterol oxidase; ecdysone inhibitors; HMG-COA reductase; ion channel inhibitors such as a sodium channel inhibitors and calcium channel inhibitors; juvenile hormone esterase; diuretic hormone acceptors; stilbene synthetase; bibenzyl synthetase; chitinase; and glucanase.

The toxins expressed in such transgenic soybean and transgenic cotton include δ-endotoxin proteins such as Cry1Ab, Cry1Ac, Cry1F, Cry1Fa2, Cry2Ab, Cry3A, Cry3Bb1, Cry9C, Cry34Ab and cry35Ab, hybrid toxins of insecticidal proteins such as VIP1, VIP2, VIP3 and VIP3A, partially deficient toxins, and modified toxins. The hybrid toxins are fabricated by a novel combination of the different domains of such proteins, using genetic recombination technology. The known partially deficient toxin is Cry1Ab, in which a part of amino acid sequence is deficient. In modified toxins, one or more amino acids of a natural toxin are replaced. Examples of such toxins and transgenic plants capable of synthesizing such toxins are described in EP-A-0 374 753, WO 93/07278, WO 95/34656, EP-A-0 427 529, EP-A-451 878, and WO 03/052073. The toxins contained in such transgenic plants impart resistance to insect pests of Coleoptera, insect pests of Diptera and insect pests of Lepidoptera to the plants .

Rag1 (Resistance Aphid Gene1) gene is known as gene resistant to pests, and soybean containing this gene introduced thereinto is known.

It has already been known that there are transgenic soybean and transgenic cotton containing one or more insecticidal pest-resistant genes and capable of producing one or more toxins. Some of them are commercially available. Examples of such transgenic soybean and transgenic cotton include Bollgard® I (cotton cultivar expressing a Cry1Ac toxin), Bollgard® II (cotton cultivar expressing Cry1Ab and Cry2Ab toxins) and VIPCOT® (cotton cultivar expressing a VIP toxin).

The above transgenic soybean and transgenic cotton include those provided with a capacity of producing an anti-pathogenic substance having selective activity. As the anti-pathogenic, PR proteins (PRPs, described in EP-A-0 392 225) are known. These anti-pathogenic substances and genetically modified plants producing thereof are described in EP-A-0 392 225, WO 95/33818, and EP-A-0 353 191. Examples of the anti-pathogenic substance expressed by such transgenic plants include ion channel inhibitors, such as a sodium channel inhibitor and calcium channel inhibitor (KP1, KP4 and KP6 toxins produced by viruses are known); stilbene synthases; bibenzyl synthases; chitinase; glucanase; PR proteins; and substances produced by microorganisms, such as peptide antibiotics, antibiotics having a heterocyclic ring and protein factors (called genes resistant to plant diseases and are described in WO 03/000906) involved in plant disease resistance.

The above plants include those provided with useful traits, such as reformed oil component and enhanced amino acid content, by means of genetic recombination technique. The crops are exemplified by VISTIVE® (low linolenic soybean with reduced linolenic acid content).

The plants further include stacked varieties, which are fabricated by combining the above classical herbicidal traits or herbicide resistant genes, insecticidal pest resistant genes, anti-pathogenic substance-producing genes, reformed oil component and enhanced amino acid content.

According to the method of controlling weeds of the present invention, weeds in the soybean or cotton field can be effectively controlled.

Examples of weeds, which can be controlled by the method of controlling weeds of the present invention, include: weeds belonging to Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa, weeds belonging to Portulacaceae: Portulaca oleracea, weeds belonging to Caryophyllaceae: Stellaria media, Cerastium holosteoides, Cerastium glomeratum, Spergula arvensis, weeds belonging to Chenopodiaceae: Chenopodium album, Kochia scoparia, Salsola kali, Atriplex spp., weeds belonging to Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Alternanthera philoxeroides, Alternanthera sessilis, weeds belonging to Papaveraceae: Papaver rhoeas, weeds belonging to Brassicaceae: Raphanus raphanistrum, Sinapis arvensis, Capsella bursa-pastoris, Brassica juncea, Descurainia pinnata, Rorippa islandica, Rorippa sylvestris, Thlaspi arvense, weeds belonging to Leguminosae: Aeschynomene indica, Sesbania exaltata, Cassia obtusifolia, Cassia occidentalis, Desmodium tortuosum, Trifolium repens, Pueraria lobata, Vicia angustifolia, weeds belonging to Oxalidaceae: Oxalis corniculata, Oxalis strica, weeds belonging to Geraniaceae: Geranium carolinense, Erodium cicutarium, weeds belonging to Euphorbiaceae: Euphorbia helioscopia, Euphorbia maculata, Euphorbia humistrata, Euphorbia esula, Euphorbia heterophylla, Acalypha australis, weeds belonging to Malvaceae: Abutilon theophrasti, Sida spinosa, Hibiscus trionum, weeds belonging to Violaceae: Viola arvensis, Viola tricolor weeds belonging to Cucurbitaceae: Sicyos angulatus, Echinocystis lobata, weeds belonging to Lythraceae: Lythrum salicaria, weeds belonging to Apiaceae: Hydrocotyle sibthorpioides, weeds belonging to Asclepiadaceae: Asclepias syriaca, Ampelamus albidus, weeds belonging to Rubiaceae: Galium aparine, Galium spurium var. echinospermon, Spermacoce latifolia, weeds belonging to Convolvulaceae: Ipomoea nil, Ipomoea hederacea, Ipomoea purpurea, Ipomoea hederaceavar var integriuscula, Ipomoea lacunosa, Ipomoea triloba, Ipomoea coccinea, Ipomoea quamoclit, Convolvulus arvensis, Calystegia hederacea, weeds belonging to Boraginaceae: Myosotis arvensis, weeds belonging to Lamiaceae: Lamium purpureum, Lamium ample xicaule, weeds belonging to Solanaceae: Datura stramonium, Solanum nigrum, Solanum americanum, Solanum ptycanthum, Solanum sarrachoides, Solanum rostratum, Solanum aculeatissimum, Solanum carolinense, Physalis angulata, Physalis subglabrata, Nicandra physaloides, weeds belonging to Scrophulariaceae: Veronica hederaefolia, Veronica persica, Veronica arvensis, weeds belonging to Plantaginaceae: Plantago asiatica, weeds belonging to Asteraceae: Xanthium pensylvanicum, Xanthium occidentale, Helianthus annuus, Matricaria chamomilla, Matricaria perforata, Chrysanthemum segetum, Matricaria matricarioides, Artemisia princeps, Solidago altissima, Taraxacum officinale, Galinsoga ciliata, Senecio vulgaris, Conyza bonariensis, Conyza canadensis, Ambrosia artemisiaefolia, Ambrosia trifida, Bidens pilosa, Bidens frondosa, Cirsium arvense, Cirsium vulgare, Carduus nutans, Lactuca serriola, Sonchus asper, weeds belonging to Liliaceae: Allium canadense, Allium vineale weeds belonging to Commelinaceae: Commelina communis, Commelina bengharensis, weeds belonging to Poaceae: Echinochloa crus-galli, Setaria viridis, Setaria faberi, Setaria glauca, Digitaria ciliaris, Digitaria sanguinalis, Eleusine indica, Poa annua, Alospecurus aequalis, Alopecurus myosuroides, Avena fatua, Sorghum halepense, Sorghum vulgare, Agropyron repens, Lolium multiflorum, Loliumperenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Brachiaria platyphylla, Cenchrus echinatus, Cenchrus pauciflorus, Eriochloa villosa, weeds belonging to Cyperaceae: Cyperusmicroiria, Cyperusiria, Cyperus rotundus, Cyperus esculentus, Kyllinga gracillima weeds belonging to Equisetaceae: Equisetum arvense, Equisetum palustre and the like.

In the method of controlling weeds of the present invention, one or more kinds of other agricultural chemicals can be used in combination. Examples of other agricultural chemicals include insecticides, acaricides, nematocides, fungicides, heribicides, plant growth regulators and safeners.

Examples of other agricultural chemicals include: insecticides: fenthion, fenitrothion, pirimiphos-methyl, diazinon, quinalphos, isoxathion, Pyridafenthion, chlorpyrifos-methyl, vamidothion, malathion, phenthoate, dimethoate, disulfoton, monocrotophos, tetrachlorvinphos, chlorfenvinphos, propaphos, acephate, trichlorphon, EPN, pyraclorfos, carbaryl, metolcarb, isoprocarb, BPMC, propoxur, XMC, carbofuran, carbosulfan, benfuracarb, furathiocarb, methomyl, thiodicarb, cycloprothrin, ethofenprox, cartap, bensultap, thiocyclam, buprofezin, tebufenozide, ethiprole and pyridalyl. acaricides: hexythiazox, pyridaben, fenpyroximate, tebufenpyrad, chlorfenapyr, etoxazole, pyrimidifen, and spirodiclofen. fungicides: captan, IBP, EDDP, tolclofos-methyl, benomyl, carbendazim, thiophanate-methyl, mepronil, flutolanil, thifluzamid, furametpyr, teclofthalam, pencycuron, carpropamid, diclocymet, metalaxyl, triflumizole, azaconazole, bromuconazole, cyproconazole, diclobutrazol, difenoconazole, diniconazole, diniconazole-M, epoxiconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, pefurazoate, prochloraz, azoxystrobin, dimoxystrobin, fluoxastrobin, kresoxim-methyl, metominostrobin, orysastrobin, picoxystrobin, pyraclostrobin, trifloxystrobin, validamycin A, blasticidin S, kasugamycin, polyoxin, fthalide, probenazole, isoprothiolane, tricyclazole, pyroquilon, ferimzone, acibnzolar S-methyl, diclomezine, oxolinic acid, phenazine oxide, TPN, and iprodione. herbicides: 2,4-D, 2,4-DB, MCPA, MCPB, mecoprop, mecoprop-P, dichlorprop, dichlorprop-P, bromoxynil, dichlobenil, ioxynil, di-allate, butylate, tri-allate, phenmedipham, chlorpropham, asulam, phenisopham, benthiocarb, molinate, esprocarb, pyributicarb, prosulfocarb, orbencarb, EPIC, dimepiperate, swep, propachlor, metazachlor, alachlor, acetochlor, metolachlor, S-metolachlor, butachlor, pretilachlor, thenylchlor, aminocyclopyrachlor, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, bennzobicyclon, dithiopyr, triclopyr, thiazopyr, aminopyralid, clopyralid, dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazaquin, imazethapyr, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glufosinate, glufosinate-ammonium, glufosinate-P, glufosinate-P-sodium, bialafos, anilofos, bensulide, butamifos, diflufenzopyr, diflufenzopyr-sodium, paraquat, and diquat. plant growth regulators (regulator-activating components): hymexazol, paclobutrazol, uniconazole, uniconazole-P, inabenfide, prohexadione-calcium, 1-methylcyclopropene, trinexapac, and gibberellins. safeners: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, and oxabetrinil.

### EXAMPLES

The present invention will be described specifically by way of Examples, but the present invention is not limited to these Examples.

In the following description, “ha” means hectare, in other words, 10,000 m².

In the following Examples, herbicidal activity was evaluated by the following “evaluation criteria”.

### [Evaluation Criteria]

The herbicidal activity was evaluated by the following criteria. The score is divided into 0 to 100 based on the reduction in shoot biomass which is visually evaluated, comparing with the comparative samples in which the seeding was conducted in the same manner as test sample except that no chemicals were applied. When the emergence or growth of test weeds is almost or completely the same as the emergence or growth in comparative samples, the score is “0”. When the test weeds are completely dead, or emergence or growth of the weeds is completely suppressed, the score is “100”.

### Example 1

A plastic pot measuring 177 mm in inner diameter and 140 mm in height was filled with the soil, and seeds of soybean, Portulaca oleracea, Amaranthus retroflexus and Spergula arvensis were sown.

On the day of seeding, a predetermined amount of a dicamba diglycolamine salt liquid formulation (liquid formulation containing 56.8% dicamba diglycolamine salt, manufactured by BASF Corporation under the trade name of Clarity) and a predetermined amount of a flumioxazin granular wettable powder (granular wettable powder containing 51% flumioxazin, manufactured by Valent USA under the trade name of Valor SX) were mixed and the mixture was diluted with water. This water dilution was uniformly sprayed over a surface of the soil in each amount shown in Table 1 using a sprayer.

For comparison, the seeding was conducted in the same manner as mentioned above, except that the water dilution was not sprayed.

Both the pots with treated soils and the pot with untreated soils were placed in a greenhouse and, after 11 days, each herbicidal activity was evaluated. The results are shown in Table 1.

TABLE 1

| Application amount of Test | Evaluation of activity against |
|---|---|
| compounds (g/ha) | weeds (Portulaca oleracea, |

| Dicamba | | Amaranthus retroflexus L. and |
|---|---|---|
| diglycolamine salt | Flumioxazin | Spergula arvensis var. sativa.) |
| 6 | 1 | 80 |
| 6 | 10 | 100 |
| 60 | 1 | 95 |
| 60 | 10 | 100 |

### Example 2

A plastic pot measuring 177 mm in inner diameter and 140 mm in height was filled with the soil, and seeds of soybean were sown and the plastic pot was placed in a greenhouse. After 3 days, seeds of Ipomoea hederacea were sown in the same pot and then placed in a greenhouse.

Ten days after sowing seeds of soybean, a predetermined amount of a dicamba diglycolamine salt liquid formulation (liquid formulation containing 56.8% dicamba diglycolamine salt, manufactured by BASF Corporation under the trade name of Clarity) and a predetermined amount of a flumioxazin granular wettable powder (granular wettable powder containing 51% flumioxazin, manufactured by Valent USA under the trade name of Valor SX) were mixed and the mixture was diluted with water. This water dilution was uniformly sprayed over weeds and a surface of the soil in each amount shown in Table 2 using a sprayer. For comparison, the seeding was conducted in the same manner as mentioned above, except that the water dilution was not sprayed.

Both the pots with treated soils and the pot with untreated soil were placed in a greenhouse and, after 4 days, activity against Ipomoea hederacea was evaluated. The results are shown in Table 2.

TABLE 2

Application amount of Test
compounds (g/ha)

| Dicamba | | Activity against |
|---|---|---|
| diglycolamine salt | Flumioxazin | Ipomoea hederacea |
| 0.74 | 10 | 99 |
| 7.4 | 1 | 99 |
| 7.4 | 10 | 99 |
| 74 | 1 | 99 |

### Example 3

A plastic pot measuring 177 mm in inner diameter and 140 mm in height was filled with the soil, and seeds of cotton were sown and the plastic pot was placed in a greenhouse. After 3 days, seeds of Ipomoea hederacea were sown in the same pot and then placed in a greenhouse.

Ten days after sowing seeds of cotton, a predetermined amount of a dicamba diglycolamine salt liquid formulation (liquid formulation containing 56.8% dicamba diglycolamine salt, manufactured by BASF Corporation under the trade name of Clarity) and a predetermined amount of a flumioxazin granular wettable powder (granular wettable powder containing 51% flumioxazin, manufactured by Valent USA under the trade name of Valor SX) were mixed and the mixture was diluted with water. This water dilution was uniformly sprayed over weeds and a surface of the soil in each amount shown in Table 3 using a sprayer. For comparison, the seeding was conducted in the same manner as mentioned above, except that the water dilution was not sprayed.

Both the pots with treated soils and the pot with untreated soil were placed in a greenhouse and, after 4 days, activity against Ipomoea hederacea was evaluated. The results are shown in Table 3.

TABLE 3

Application amount of Test
compounds (g/ha)

| Dicamba | | Activity against |
|---|---|---|
| diglycolamine salt | Flumioxazin | Ipomoea hederacea |
| 0.74 | 10 | 99 |
| 7.4 | 1 | 99 |
| 7.4 | 10 | 99 |
| 74 | 1 | 99 |

The method of the present invention is useful for controlling weeds in a soybean or cotton field.

What is claimed is:

1. A method of controlling weeds in a soybean or cotton field, which comprises the step of applying an effective amount of flumioxazin and dicamba or an agriculturally acceptable salt thereof to the weeds or a place where the weeds are to grow.

2. The method of controlling weeds according to claim 1, wherein a mixing weight ratio of flumioxazin to dicamba or an agriculturally acceptable salt thereof is from 1:0.001 to 1:600.

3. The method of controlling weeds according to claim 1, wherein a mixing weight ratio of flumioxazin to dicamba or an agriculturally acceptable salt thereof is from 1:0.01 to 1:300.

4. The method of controlling weeds according to claim 1, wherein a mixing weight ratio of flumioxazin to dicamba or an agriculturally acceptable salt thereof is from 1:1 to 1:150.

5. The method of controlling weeds according to claim 1, wherein the soybean field is for cultivating a transgenic soybean and wherein the cotton field is for cultivating a transgenic cotton.

6. The method of controlling weeds according to claim 1, wherein the soybean field is for cultivating a herbicide-resistant transgenic soybean and wherein the cotton field is for cultivating a herbicide-resistant transgenic cotton.

7. The method of controlling weeds according to claim 1, wherein the soybean field is for cultivating a dicamba-resistant transgenic soybean and wherein the cotton field is for cultivating a dicamba-resistant transgenic cotton.
